(19) United States
(12) Patent Application Publication
(10) Pub. No.: US 2004/0115398 A1
(43) Pub. Date: Jun. 17, 2004

(54) Laminated siding panels having preselected colors

(76) Inventors: Joe R. Regelski, Venetia, PA (US); Thomas L. Levendusky, Greensburg, PA (US); Gary White, Sherman, TX (US)

Correspondence Address: ECKERT SEAMANS CHERIN & MELLOTT, LLC, ALCOA TECHNICAL CENTER, 100 TECHNICAL DRIVE, ALCOA CENTER, PA, 15069-0001, US

(21) Appl. No.: 10/318,427

(22) Filed: Dec. 13, 2002

(51) Int. Cl. B32B 1/00

(52) U.S. Cl. 428/141; 264/171.1; 264/175; 264/284

(57) ABSTRACT

Plastic panels for exterior use on buildings are made by forming a plastic sheet at an elevated temperature, overlaying an exterior surface portion of the formed sheet with a coloring sheet having a preselected color, and thermally bonding the coloring sheet to the formed sheet. The coloring sheet preferably comprises a vinyl resin plastisol and pigment particles. Both the formed sheet and the vinyl resin in the plastisol preferably comprise polyvinyl chloride (PVC). Use of the coloring sheet enables color changes to be accomplished quickly and inexpensively so that manufacturers are able to maintain smaller inventories of the finished product while still satisfying customer needs.

### FIELD OF THE INVENTION

The present invention relates to a process for making laminated plastic siding panels suitable for use on buildings. More specifically, the invention relates to a process for making vinyl siding panels having preselected colors, wherein the colors of panels made on an extrusion line can be changed more quickly and less expensively than in the prior art.

### BACKGROUND OF THE INVENTION

Processes for making plastic siding panels having preselected colors are known in the prior art. The most commonly used process in commercial use at the present time involves coextruding at least two molten layers each including polyvinyl chloride (PVC) and various additives. Both the topcoat and the basecoat layers contain organic or inorganic pigments, fillers, heat stabilizers, impact modifiers, processing aids, and lubricants. Other suitable additives include antioxidants, flame retardants, and light stabilizers. Generally the basecoat layer is thicker than the topcoat layer and the basecoat layer contains a smaller proportion of pigments and other additives, in order to reduce material costs.

Thermoplastic polymers other than PVC may be used for making extruded plastic siding panels. Some other useful thermoplastic polymers include polyolefins (e.g. polypropylene and polyethylene), polycarbonates, acrylics, polyvinyl fluorides, polystyrenes, cellulosics, and nylons. PVC is the most preferred thermoplastic polymer for use in the present invention.

Plastic siding panels produced commercially nowadays are made in a variety of attractive colors and they are usually embossed with simulated wood grain patterns. The colors must resist fading even after exposure to outdoor light for several years. Siding panels must also be strong enough to resist high winds, must have a relatively high flexural modulus, and must be resistant to distortion accompanying temperature changes. Because plastic siding panels possess these desirable attributes and are still relatively inexpensive compared with wood and metal, they have achieved widespread use in North America on exterior surfaces of residential and commercial buildings.

Plastic siding panels are generally manufactured in long runs of a single color, usually carried out for 24 hours or more. Siding manufacturers are reluctant to operate their extruders for shorter times because changeovers from one color to a different color require a downtime of at least several minutes because of the need to change the color of at least one layer fed to the extruder. As a result, siding manufacturers are forced to maintain larger inventories of many siding colors than they otherwise keep to satisfy customer demand. Accordingly, there remains an opportunity for a process of producing plastic siding panels in a variety of preselected colors, wherein color changes can be accomplished quickly, efficiently, and economically.

A principal objective of the patent invention is to provide a process for making laminated plastic siding panels suitable for use on buildings, wherein changeovers from one color to another can be accomplished quickly and inexpensively.

A related objective of the present invention is to provide a coloring sheet to be laminated with a plastic sheet for production of laminated siding panels in accordance with the process of the invention.

Additional objectives and advantages of the invention will become apparent to persons skilled in the art from the following detailed description of a particularly preferred embodiment.

### SUMMARY OF THE INVENTION

In accordance with the present invention there is provided a process for making laminated plastic siding panels suitable for use on buildings. Laminated siding panels of the invention are similar to vinyl siding panels now covering building exteriors in a variety of attractive colors including Pebblestone Clay, Pine Wood, Sawmill and Musket Brown.

The laminated plastic siding panel of the invention comprises a plastic sheet to which a coloring sheet is bonded, to impart a desired color. The plastic sheet may comprise a single layer or less preferably two or more layers bonded to each other. The plastic sheet is preferably extruded from molten polymer compounds containing thermoplastic polymers and other additives. Some useful thermoplastic polymers include polyvinyl chloride (PVC), polyolefins (e.g. polypropylene and polyethylene), polycarbonates, acrylics, polystyrenes, cellulosics, nylons, and other suitable thermoplastics. PVC is the particularly preferred thermoplastic polymer for practice of the present invention. If desired, some of the PVC may be reprocessed scrap material.

The plastic sheet contains various additives in addition to PVC. Such additives include various pigments, fillers, heat stabilizers, impact modifiers, processing aids, and lubricants. Other suitable additives include antioxidants, flame retardants, and light stabilizers. Some suitable pigments and fillers include titanium dioxide, calcium carbonate, kaolin clay, silica, talc, zinc oxide, magnesium hydroxide, alumina trihydrate, Pigment Red 101 (iron oxide red), Pigment Yellow 119 (zinc iron pigment), Pigment Green 48, and organic pigments of various colors.

The heat stabilizer additives are preferably organotin compounds including the alkyl mercaptides, maleates, and carboxylates. Some examples of suitable organotin stabilizers are dialkyltin allyl mercaptides, dibutyltin maleate, modified butyltin maleates, octyltin mercaptocarboxylic acids, dibutyltin dilaurate, and organotin derivatives of 2-mercaptoethanol. The organotin stabilizer preferably is present at a concentration of about 0.2-2 parts per 100 parts unplasticized polyvinyl chloride resin (0.2-2 phr). Other heat stabilizers for PVC include β-diketones and mixed metal carboxylates. The impact modifiers may comprise chlorinated polyethylene, acrylic polymers, acrylonitrile-butadiene-styrene resins, ethylene- vinyl acetate copolymers, and ethylene-vinyl acetate/vinyl chloride graft copolymers. One suitable group of impact modifiers is sold by Rohm & Haas Company under the trademark ACRYLOID. The impact modifiers are typically employed at a level of about 0.4-10 phr.

A suitable processing aid is a low viscosity acrylic copolymer. Some useful lubricants include calcium, aluminum, magnesium and zinc stearates, and various soaps, waxes, and fatty acid derivatives. Optionally, the plastic sheet may contain any of several antimicrobial compounds to prevent mildew, including various isothiazolones and diphenyl ethers.

In accordance with the invention a molten polymer compound is extruded through an opening in an extrusion die to form a molten plastic sheet. Less preferably, the molten plastic sheet may be formed by coextruding two or more webs through adjacent extrusion dies and then pressing the webs together while they are still in a viscoelastic state.

In order to impart a desired color to the plastic panel of the invention, the molten plastic sheet is laminated with a coloring sheet. The coloring sheet of the invention is formed into a sheet by any of several techniques including extrusion, blowing, spread coating, electrostatic casting or solution casting and is preferably made by spread coating a film comprising a binder, at least one plasticizer for the binder, at least one organic solvent, and particles of a pigment imparting a preselected color; heating the film to drive off at least some of the solvent, thereby forming a coloring sheet; and winding the coloring sheet into a roll for later lamination with the plastic sheet.

The binder is preferably vinyl resin plastisol comprising a vinyl resin, at least one plasticizer for the vinyl resin and at least one organic solvent. The vinyl resin comprises at least one resin selected from vinyl chloride homopolymers, copolymers of vinyl chloride with vinylidene chloride or with vinyl esters of carboxylic acids containing 2 to 10 carbon atoms; and acrylate homopolymers and copolymers. Plastisols of polyvinyl chloride (PVC) are particularly preferred. Plastisols may also include acrylics and/or polyvinylidene fluoride, alone or in combination with a vinyl resin.

The plasticizer for the vinyl resin may be a carboxylic acid diester, tricresyl phosphate and other esters of orthophosphoric acid, acetyltributyl citrate, or a saturated or unsaturated polyester of liquid epoxide compounds. Some preferred plasticizers are diesters of dicarboxylic acids with saturated alcohols, including diusodecyl phthalate; nonanedioic acid, bis (ethylhexyl) ester; and trimethyl-1, 3-pentanediol diusobutyrate. The organic solvent may be naphtha, toluene, xylene, mineral spirits, and mixtures including such solvents.

Some suitable pigments imparting color to the coloring sheet include titanium dioxide, aluminum trihydroxide, iron oxide, silica, calcium carbonate, zinc oxide, magnesium hydroxide, carbon black, various organic pigments, and mixtures thereof Coloring sheets made in accordance with the invention generally contain some titanium dioxide. Other pigments in the coloring sheet will vary, depending upon the particular color to be imparted to the sheet. The vinyl plastisol preferably also includes a thixotropic agent such as amorphous silica; an anti-chalking agent such as antimony trioxide, and optionally an ultraviolet stabilizer. Optionally, an antimicrobial compound may be added to the plastisol. Suitable antimicrobial compounds include isothiazolones and diphenyl ethers.

The coloring sheet is laminated to the extruded plastic sheet by overlaying the plastic sheet with a coloring sheet and then passing the coloring sheet through a pair of opposed, rotating rolls. At least one of the opposed rolls is preferably a steel embossing roll which impresses an embossed, simulated wood grain pattern into the coloring sheet and the underlying plastic sheet. Shaper dies then shape the panel into a desired three-dimensional configuration while it is still in a viscoelastic condition, preferably so that reheating is avoided. The shaped panel is solidified by cooling, preferably with water, and then punched with openings and cut into desired lengths for packaging, followed by shipment to customers.

### BRIEF DESCRIPTION OF THE DRAWINGS

FIG. 1 is a flow sheet diagram of a particularly preferred process for making laminated plastic siding panels in accordance with the invention. FIG. 2 is a flow sheet diagram of a preferred process for making the coloring sheet of the invention.

### DETAILED DESCRIPTION OF PREFERRED EMBODIMENTS

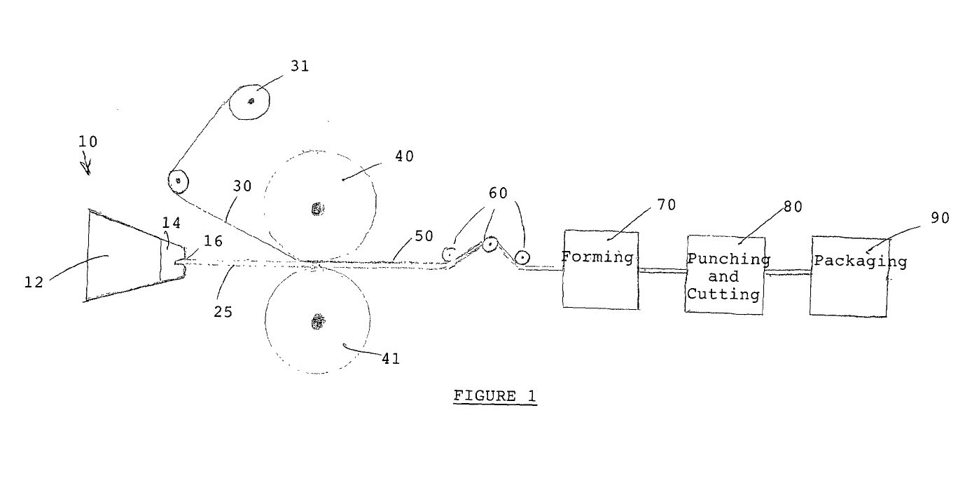

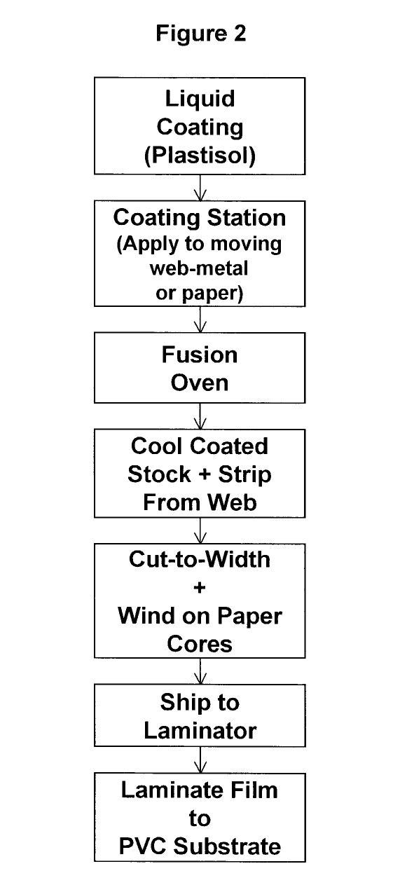

As shown in FIG. 1, an apparatus 10 for making laminated plastic siding panels in accordance with the invention includes an extruder 12 connected with a steel extrusion die 14 having a linear opening 16. The extruder 12 and die 14 are commercially available from American Maplan Corporation, of Mc Pherson, Kans., in a variety of designs and sizes that are adaptable to the quantity and speed of extrudate desired for particular applications.

The extrusion die 14 extrudes a molten plastic sheet 25 at an elevated temperature of at least about 300° F. (149° C.).

In order to impart a preselected color to the product, a coloring sheet 30 is laminated with the plastic sheet 25. The coloring sheet 30 is unwound from a supply roll 31 and fed continuously to a metal embossing roll 40 and a rubber backup roll 41, together with the plastic sheet 25. The plastic sheet 25 leaves the extruder die 14 at a temperature of about 385-400° F. When the plastic sheet 25 meets the coloring sheet 30 between the rolls 40, 41 the temperature of the sheet 25 is still high enough to bond the coloring sheet 30 to an outer surface portion of the plastic sheet 25. The embossing roll 40 simultaneously imparts a three-dimensional simulated wood grain texture to the coloring sheet 30. The product, a laminated plastic panel 50 having an appearance similar to painted wood, is feed downstream to cooling rolls 60, a forming station 70 where the panel 50 is shaped into a desired configuration, then to a punching and cutting station 80 where holes are punched and the panel 50 is cut into desired lengths. Finally, at a packaging station 90 the product is boxed for shipment directly to customers or for temporary storage in the manufacturer's inventory.

As shown in FIG. 2, coloring sheet of the invention is preferably made by a process that includes spread coating a thin film of vinyl plastisol onto a paper sheet, heating the thin film in a fusion oven to drive off some of the solvent in the plastisol, cooling the film, stripping the film from the paper sheet, cutting the coloring sheet to a desired width, and then winding the dried coloring sheet onto paper cores. Alternatively, the coloring sheet may be made by casting a thin film of the plastisol onto a moving web (paper, metal or polymer).

The vinyl plastisol of the invention comprises a dispersion of finely divided plasticized polyvinyl chloride. The plastisol may comprise about 25-50 wt % PVC, preferably about 42-48 wt %, and about 45 wt % in a particularly preferred embodiment. The plasticizer comprises about 16-24 wt % of the plastisol, preferably about 20-23 wt %, and about 21 wt % in a particularly preferred embodiment. A particularly preferred plastisol contains 3 plasticizers—about 9.9 wt % diusodecyl phthalate; about 5.9 wt % nonanedioic acid, bis (ethylhexyl) ester; and about 5.4 wt % trimethyl-1,3-pentaediol diisobutyrate.

The vinyl plastisol may contain about 18-35 wt % pigment particles, preferably about 20-25 wt % in a particularly preferred embodiment. A particularly preferred composition includes about 21.0 wt % titanium dioxide to impart a whitish color and to protect the PVC from light, about 1.2 wt % aluminum hydroxide, and about 1.2 wt % amorphous silica. The silica also acts as a thioxotropic agent.

The plastisol includes about 5-15 wt % organic solvents. Some suitable solvents include toluene, naphtha, xylene, mineral spirits, and solvent mixtures including such solvents.

Other suitable additives in the vinyl plastisol include anti-chalking agents, UV light stabilizers, and fumed silica for reducing gloss. A particularly preferred plastisol contains about 0.6 wt % antimony trioxide, an anti-chalking agent.

Having described the presently preferred embodiments, it is to be understood that the invention may be otherwise embodied within the scope and spirit of the appended claims.

What is claimed is:

1. A process for making laminated plastic panels suitable for use on buildings and having a preselected color, comprising
forming a plastic sheet at an elevated temperature, the formed sheet having an exterior surface portion,
overlaying the exterior surface portion of the formed sheet with a coloring sheet having a preselected color and comprising a polymeric binder and pigment particles, said binder comprising a plastisol, and
laminating the coloring sheet to the formed sheet by means of a roll continuously contacting the coloring sheet, said formed sheet maintaining a sufficient temperature while pressure is applied to the roll to bond said coloring sheet to said formed sheet, thereby to produce a laminated plastic panel having a preselected color.

2. The process of claim 1, wherein said step of forming the plastic sheet comprises extruding said plastic sheet through an exit opening in an extusion die.

3. The process of claim 1, further comprising shaping the laminated plastic panel into a desired configuration.

4. The process of claim 1, wherein said polymeric binder in the coloring sheet comprises a plastisol of at least one resin selected from vinyl resins, acrylics, and polyvinylidene fluroide.

5. The process of claim 4, wherein said plastisol comprises a vinyl resin selected from the group consisting of vinyl chloride homopolymers; copolymers of vinyl chloride with vinylidene chloride or vinyl esters of carboxylic acids containing 2 to 10 carbon atoms; and acrylate homopolymers and copolymers.

6. The process of claim 5, wherein said vinyl resin comprises polyvinyl chloride.

7. The process of claim 5, wherein said plastisol further comprises a plasticizer for the vinyl resin.

8. The process of claim 4, wherein said plastisol comprises polyvinyl chloride and at least one plasticizer selected from the group consisting of diesters of carboxylic acids with saturated and unsaturated alcohols; esters of orthophosphoric acid; acetyltributyl citrate; and saturated and unsaturated polyesters of liquid epoxide compounds.

9. The process of claim 1, wherein said pigment particles include at least one substance selected from the group consisting of titanium dioxide, aluminum trihydroxide, iron oxide, silica, calcium carbonate, carbon black, and mixtures thereof.

10. The process of claim 1, wherein said coloring sheet further comprises antimony trioxide.

11. The process of claim 1, wherein said plastic sheet comprises a thermoplastic polymer selected from the group consisting of polyvinyl chloride, polyolefins, polycarbonates, acrylics, polyvinylidene fluoride, polystyrenes, cellulosics and nylons.

12. The process of claim 1, wherein said plastic sheet comprises polyvinyl chloride.

13. A process for making laminated plastic panels having a preselected color, comprising extruding a plastic sheet an elevated temperature through an exit opening in an extruder die, the extruded sheet having an exterior surface portion,
overlaying the exterior surface portion of the extruded sheet with a coloring sheet having a preselected color and comprising pigment particles dispersed in a plastisol comprising a vinyl resin and at least one plasticizer for the vinyl resin,
laminating the coloring sheet to the extruded sheet by means of a roll contacting the coloring sheet, said extruded sheet maintaining a sufficient temperature while pressure is applied to the roll to bond said coloring sheet to said extruded sheet, thereby to produce a laminated plastic panel comprising an extruded plastic sheet bonded to said coloring sheet.

14. The process of claim 13, wherein said roll comprises an embossing roll, and further comprising
embossing a surface roughness into said coloring sheet,
forming said plastic panel into a desired configuration while it is still in a viscoelastic state,
cooling said formed plastic panel, and
cuffing said plastic panel into desired lengths.

15. The process of claim 13, wherein said coloring sheet is made by forming a film comprising a vinyl resin, at least one plasticizer for the vinyl resin, an organic solvent, and pigment particles; heating the film to drive off at least some of the solvent and to form a coloring sheet; and winding the coloring sheet into a roll.

16. The process of claim 15 wherein said film is formed by spread coating or by solution casting.

17. A laminated plastic panel comprising
a plastic sheet comprising polyvinyl chloride and pigment particles, and
a coloring sheet thermally bonded to a surface portion of said plastic sheet, said coloring sheet comprising a vinyl resin plastisol including a vinyl resin and at least one plasticizer, and pigment particles dispersed in said plastisol, said pigment particles imparting a preselected color to said plastic panel.

18. The panel of claim 17, wherein a three-dimensional surface roughness is embossed into a surface portion of said coloring sheet.

19. The panel of claim 17, wherein said plasticizer comprises an ester of a dicarboxylic acid.

20. The panel of claim 17, wherein said plastisol further comprises an organic solvent.
